(19) United States
(12) Patent Application Publication
(10) Pub. No.: US 2019/0289095 A1
(43) Pub. Date: Sep. 19, 2019

(54) SYSTEMS AND METHODS FOR OFFERING DIFFERENT VIDEO CONTENT TO DIFFERENT GROUPS OF USERS

(71) Applicant: GOPRO, INC., San Mateo, CA (US)

(72) Inventors: Alexandre Jenny, Challes les eaux (FR); David Newman, San Diego, CA (US); Xavier Farret, San Mateo, CA (US); Samy Aboudrar, San Mateo, CA (US); Claire Mathis, San Mateo, CA (US)

(21) Appl. No.: 15/285,146

(22) Filed: Oct. 4, 2016

Related U.S. Application Data
(60) Provisional application No. 62/371,154, filed on Aug. 4, 2016.

(51) Int. Cl. H04L 29/08; H04L 12/24

(52) U.S. Cl. CPC H04L 67/327; H04N 21/4358; H04L 41/0893; H04L 67/22

(57) ABSTRACT

Interaction information may be received. The interaction information may indicate a user's spatial selections of video content as a function of progress through the video content. The spatial selections of the video content may include viewing directions of the video content selected by the user as the function of progress through the video content. Related video content may be identified based on the spatial selections of the video content. Related video content may be offered to the user.

### FIELD

This disclosure relates to offering different video content to different groups of users.

### BACKGROUND

Video content including a greater content field of view than can normally be viewed within a single viewpoint may contain in different locations things/events of interest to different groups of users. It may be difficult to manually set viewpoints to follow the thing/event of interest during playback for different groups of users. User may find it hard to find video content with viewpoints tailored to their interests.

### SUMMARY

This disclosure relates to offering different video content to different groups of users. Interaction information may be received. The interaction information may indicate a user's spatial selections of video content as a function of progress through the video content. The spatial selections of the video content may include viewing directions of the video content selected by the user as the function of progress through the video content. Related video content may be identified based on the spatial selections of the video content. Related video content may be offered to the user.

A system for offering different video content to different groups of users may include one or more physical processors, and/or other components. The physical processor(s) may be configured by machine-readable instructions. Executing the machine-readable instructions may cause the physical processor(s) to facilitate offering different video content to different groups of users. The machine-readable instructions may include one or more computer program components. The computer program components may include one or more of a receive component, an identify component, an offer component, and/or other computer program components.

The receive component may be configured to receive interaction information. The interaction information may indicate a user's spatial selections of video content as a function of progress through the video content. In some implementations, the video content may include one or more visual elements. One or more visual elements may correspond to one or more objects and/or events captured within the video content. One or more visual elements may include a first visual element corresponding to a first object and/or a first event.

Video content may refer to media content that may be consumed as one or more videos. Video content may include one or more videos stored in one or more formats/container, and/or other video content. In some implementations, the video content may include one or more of spherical video content, virtual reality content, and/or other video content. In some implementations, the spatial selections of the video content may be determined based on one or more of the users' viewing, tagging, and/or sharing of one or more portions of the video content, and/or other information.

The spatial selections of the video content may include one or more viewing directions of the video content selected by the user as the function of progress through the video content. In some implementations, the viewing directions of the video content selected by the user may be characterized by a yaw parameter, a pitch parameter, and/or other parameters. In some implementations, the viewing directions of the video content selected by the user may be further characterized by a roll parameter, and/or other parameters. In some implementations, the spatial selections of the video content may include one or more viewing extents of the video content selected by the user as the function of progress through the video content.

The identify component may be configured to identify related video content. The related video content may be identified based on the spatial selections of the video content and/or other information. In some implementations, identifying related video content based on the spatial selections of the video content may include associating the user with one or more groups and identifying the related video content based on the group(s) with which the user is associated. The user may be associated with one or more groups based on the spatial selections of the video content. In some implementations, the related video content may be characterized as being of interest to one or more groups with which the user is associated.

In some implementations, associating the user with one or more groups may include determining one or more interests of the user corresponding to one or more of objects or events based on the spatial selections of the video content and/or other information. The spatial selections of the video content may include one or more of the viewing directions of the video content selected by the user that include one or more of the visual elements. A first interest of the user corresponding to the first object or the first event may be determined based on one or more of the viewing directions of the video content selected by the user including the first visual element and/or other information.

In some implementations, the first interest of the user corresponding to the first object or the first event may be determined further based on the spatial selections of the video content indicating the user changing the viewing directions of the video content to center on the first visual element. In some implementations, the first interest of the user corresponding to the first object or the first event may be determined further based on the spatial selections of the video content indicating the user changing the viewing directions of the video content to follow the first visual element. In some implementations, the first interest of the user corresponding to the first object or the first event may be determined further based on the spatial selections of the video content indicating the user changing the viewing extents of the video content to zoom in on the first visual element. In some implementations, the first interest of the user corresponding to the first object or the first event may be determined further based on the spatial selections of the video content meeting or exceeding one or more thresholds and/or other information.

In some implementations, associating the user with one or more groups may include associating the user with one or more interest groups based on one or more interests of the user and/or other information. Individual interest groups may be characterized by a common interest of the users associated with the individual interest groups. The user may be associated with a first interest group based on the first interest of the user including a first common interest. The first interest group may be characterized by the first common interest of the users associated with the first interest group. The related video content may be identified further based on the interest group with which the user is associated and/or other information. The related video content may include a particular video content and/or other video content based on the user being associated with the first interest group and/or other information. The particular video content may include a second visual element corresponding to the first common interest and/or other visual elements.

The offer component may be configured to offer the related video content to the user. Offering the related video content user may include providing one or more links to the related video content, transmitting the related video content to the user, and/or other offerings of the related video content to the user. In some implementations, the related video content may be offered to the user based on one or more rankings of the related video content and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for offering different video content to different groups of users.

FIG. 2 illustrates a method for offering different video content to different groups of users.

FIG. 3 illustrates examples of rotational axes for video content.

FIGS. 4A-4B illustrate examples of field of view extents for video content.

FIG. 5 illustrates an example of spatial selections of video content as a function of progress through the video content.

FIG. 6 illustrates an exemplary view of video content.

FIGS. 7A-7C illustrates exemplary changed views of video content.

### DETAILED DESCRIPTION

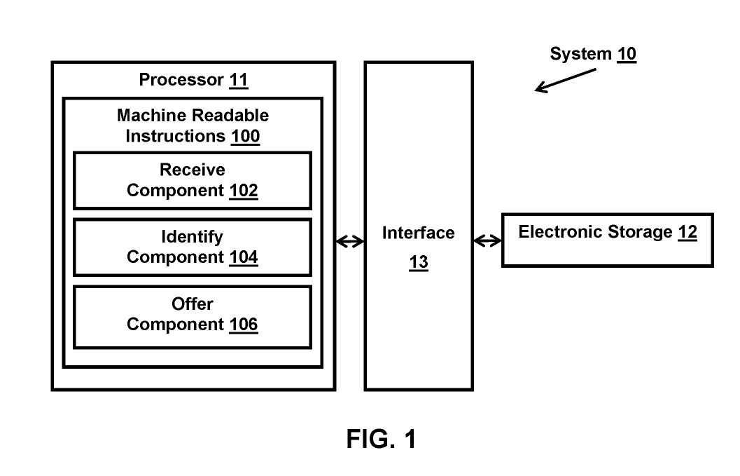

FIG. 1 illustrates system 10 for offering different video content to different groups of users. System 10 may include one or more of processor 11, electronic storage 12, interface 13 (e.g., bus, wireless interface, etc.), and/or other components. Interaction information may be received by processor 11. The interaction information may indicate a user's spatial selections of video content as a function of progress through the video content. The spatial selections of the video content may include viewing directions of the first content selected by the users as the function of progress through the video content. Related video content may be identified based on the spatial selections of the video content. Related video content may be offered to the user.

Electronic storage 12 may include electronic storage medium that electronically stores information. Electronic storage 12 may store software algorithms, information determined by processor 11, information received remotely, and/or other information that enables system 10 to function properly. For example, electronic storage 12 may store information relating to video content, interaction information, spatial selections of video content, related video content, offering related video content, groups, and/or other information.

Processor 11 may be configured to provide information processing capabilities in system 10. As such, processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. Processor 11 may be configured to execute one or more machine-readable instructions 100 to facilitate offering different video content to different groups of users. Machine-readable instructions 100 may include one or more computer program components. Machine-readable instructions 100 may include one or more of receive component 102, identify component 104, offer component 106, and/or other computer program components.

Receive component 102 may be configured to receive interaction information for one or more video content. Interaction information may indicate how one or more users interacted with the video content(s). The interaction information may indicate a user's spatial selections of video content as a function of progress through the video content. The interaction information may be received at once (e.g., interaction information for one or more users may be received after the user(s) have finished interacting with the video content) or over a period of time (e.g., interaction information for one or more users may be received as the user(s) interact with the video content). Receive component 102 may continually/periodically monitor one or more users' interactions with the video content to receive the interaction information and/or may receive the interaction information in response to a user/system prompt.

Video content may refer to media content that may be consumed as one or more videos. Video content may include one or more videos stored in one or more formats/container, and/or other video content. A video may include a video clip captured by a video capture device, multiple video clips captured by a video capture device, and/or multiple video clips captured by separate video capture devices. A video may include multiple video clips captured at the same time and/or multiple video clips captured at different times. A video may include a video clip processed by a video application, multiple video clips processed by a video application and/or multiple video clips processed by separate video applications.

In some implementations, the video content may include one or more of spherical video content, virtual reality content, and/or other video content. Spherical video content may refer to a video capture of multiple views from a single location. Spherical video content may include a full spherical video capture (360 degrees of capture) or a partial spherical video capture (less than 360 degrees of capture). Spherical video content may be captured through the use of one or more cameras/image sensors to capture images/videos from a location. The captured images/videos may be stitched together to form the spherical video content.

Virtual reality content may refer to content that may be consumed via virtual reality experience. Virtual reality content may associate different directions within the virtual reality content with different viewing directions, and a user may view a particular directions within the virtual reality content by looking in a particular direction. For example, a user may use a virtual reality headset to change the user's direction of view. The user's direction of view may correspond to a particular direction of view within the virtual reality content. For example, a forward looking direction of view for a user may correspond to a forward direction of view within the virtual reality content.

Spherical video content and/or virtual reality content may have been captured at one or more locations. For example, spherical video content and/or virtual reality content may have been captured from a stationary position (e.g., a seat in a stadium). Spherical video content and/or virtual reality content may have been captured from a moving position (e.g., a moving bike). Spherical video content and/or virtual reality content may include video capture from a path taken by the capturing device(s) in the moving position. For example, spherical video content and/or virtual reality content may include video capture from a person walking around in a music festival.

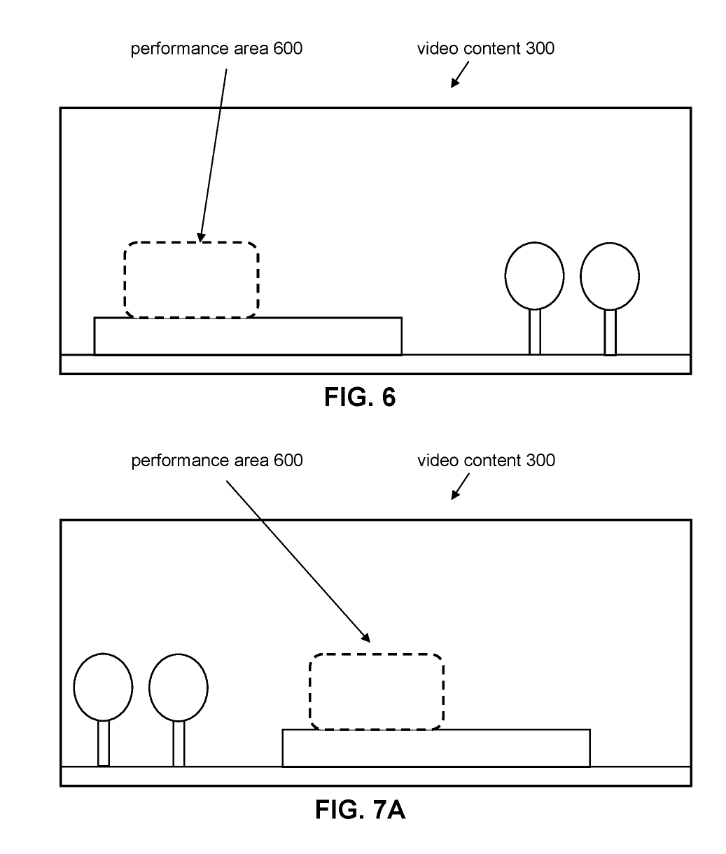

In some implementations, the video content may include one or more visual elements. One or more visual elements may correspond to one or more objects and/or events captured within the video content. One or more visual elements may include one or more visual elements corresponding to one or more objects and/or one or more events. For example, FIG. 6 illustrates an exemplary view of video content 300. Video content 300 may include spherical video content, virtual reality content, and/or other video content. Video content 300 may include visual element(s) corresponding to a music stage, visual element(s) corresponding to two trees, and visual element(s) corresponding to a music band (not shown in FIG. 6). The visual element(s) corresponding to the music band may appear within one or more portions of visual content 300 (e.g., performance area 600, etc.).

Spatial selections of the video content may refer to the one or more portions of space within the video content with which the user interacted. User's spatial selections of the video content may remain the same or change as a function of progress through the video content. For example, the user may view the video content without changing the direction of view (e.g., the user may view a “default view” of video content captured at a music festival, etc.). The user may view the video content by changing the directions of view (e.g., the user may change the direction of view of video content captured at a music festival to follow a particular band, etc.). Other types of spatial selections of the video content are contemplated.

The spatial selections of the video content may include one or more viewing directions of the video content selected by the users as the function of progress through the video content. Viewing directions of the video content may correspond to orientations of fields of view within which the users interacted with the video content. In some implementations, the viewing directions of the video content selected by the users may be characterized by a yaw parameter, a pitch parameter, and/or other parameters. In some implementations, the viewing directions of the video content selected by the users may be further characterized by a roll parameter, and/or other parameters. A yaw parameter may define an amount of yaw rotation for video content. A pitch parameter may define an amount of pitch rotation for video content. A roll parameter may define an amount of raw rotation for video content.

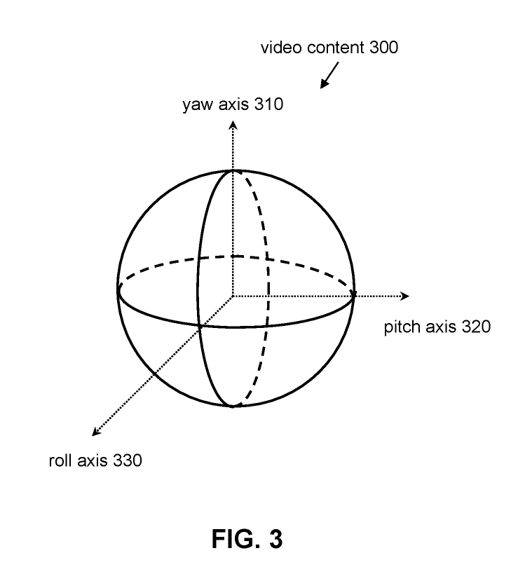

For example, FIG. 3 illustrates examples of rotational axes for video content 300. Rotational axes for video content 300 may include yaw axis 310, pitch axis 320, roll axis 330, and/or other axes. A yaw parameter may define an amount of rotation of video content 300 around yaw axis 310. For example, a 0-degree rotation of video content 300 around yaw axis 310 may correspond to a front viewing direction. A 90-degree rotation of video content 300 around yaw axis 310 may correspond to a right viewing direction. A 180-degree rotation of video content 300 around yaw axis 310 may correspond to a back viewing direction. A −90-degree rotation of video content 300 around yaw axis 310 may correspond to a left viewing direction.

A pitch parameter may define an amount of rotation of video content 300 around pitch axis 320. For example, a 0-degree rotation of video content 300 around pitch axis 320 may correspond to a viewing direction that is level with respect to horizon. A 45-degree rotation of video content 300 around pitch axis 320 may correspond to a viewing direction that is pitched up with respect to horizon by 45-degrees. A 90 degree rotation of video content 300 around pitch axis 320 may correspond to a viewing direction that is pitched up with respect to horizon by 90-degrees (looking up). A −45-degree rotation of video content 300 around pitch axis 320 may correspond to a viewing direction that is pitched down with respect to horizon by 45-degrees. A −90 degree rotation of video content 300 around pitch axis 320 may correspond to a viewing direction that is pitched down with respect to horizon by 90-degrees (looking down).

A roll parameter may define an amount of rotation of video content 300 around roll axis 330. For example, a 0-degree rotation of video content 300 around roll axis 330 may correspond to a viewing direction that is upright. A 90 degree rotation of video content 300 around roll axis 330 may correspond to a viewing direction that is rotated to the right by 90 degrees. A −90-degree rotation of video content 300 around roll axis 330 may correspond to a viewing direction that is rotated to the left by 90-degrees.

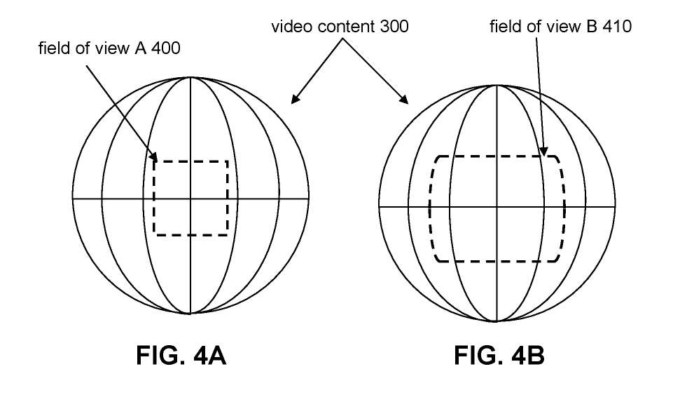

In some implementations, the spatial selections of the video content may include one or more viewing extents of the video content selected by the users as the function of progress through the video content. Viewing extents of the video content may correspond to sizes of the field of view (zoom) within which the users interacted with the video content. FIGS. 4A-4B illustrate examples of field of view extents for video content 300. In FIG. 4A, viewing extent of video content 300 may correspond to the size of field of view A 400. In FIG. 4B, viewing extent of video content 300 may correspond to the size of field of view B 410. Viewing extent of video content 300 in FIG. 4A may be smaller than viewing extent of video content 300 in FIG. 4B.

In some implementations, the spatial selections of the video content may be determined based on one or more of the users' viewing, tagging, sharing, and/or extraction of one or more portions of the video content, and/or other information. For example, users' spatial selections of the video content may be determined based on users' viewing of one or more portions of the video content via virtual reality headsets and/or other video players that allow the users to change the direction, rotation, and/or zoom of view. Users' directions, rotations, and zooms of viewing the video content may be tracked so that for different points of progress within the content, information indication the direction, rotation, and/or zoom of users' views may be stored.

Users' spatial selections of the video content may be determined based on users' tagging of one or more portions of the video content with one or more information. For example, users may tag one or more portions of the video content corresponding to a particular direction, rotation, and/or zoom as a highlight, with comments, and/or with other information.

User's spatial selections of the video content may be determined based on users' sharing of one or more portions of the video content. For example, users may share one or more portions of the video content corresponding to a particular direction, rotation, and/or zoom as a link, multiple links, an image, multiple images, a video clip, and/or multiple video clips.

Users' spatial selections of the video content may be determined based on users' extraction of one or more portions of the video content. For example, users may extract one or more portions of the video content corresponding to a particular direction, rotation, and/or zoom as an image, multiple images, a video clip, and/or multiple video clips. User's spatial selections of the video content determined based on users' other interactions with one or more portions of the video content are contemplated.

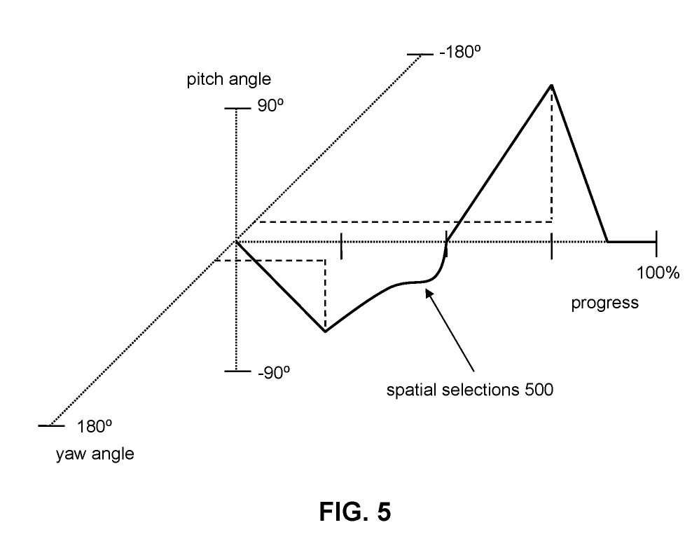

For example, FIG. 5 illustrates an exemplary spatial selections 500 of video content as a function of progress through the video content. Spatial selections 500 may correspond to a particular user's spatial selections of the video content. Spatial selections 500 may change as a function of progress through the video content. For example, at 0% progress mark, spatial selection 500 may correspond to a zero-degree yaw angle and a zero-degree pitch angle. At 25% progress mark, spatial selection 500 may correspond to a positive yaw angle and a negative pitch angle. At 50% progress mark, spatial selection 500 may correspond to a zero-degree yaw angle and a zero-degree pitch angle. At 75% progress mark, spatial selection 500 may correspond to a negative yaw angle and a positive pitch angle. At 87.5% progress mark, spatial selection 500 may correspond to a zero-degree yaw angle and a zero-degree pitch angle.

Identify component 104 may be configured to identify related video content. Related video content may refer one or more video content that may be of interest to a user. The related video content may include one or more video content similar to the video content (and/or portions of the video content) with which the user interacted. The related video content may include visuals captured at/near the same time or at/near the same location as the video content with which the user interacted. The related video content may include visual captured at different times or at different locations from the video content with which the user interacted. The related video content may be identified based on the spatial selections of the video content and/or other information. For example, identify component 104 may identify related video content based on spatial selection 500 shown in FIG. 5.

In some implementations, the related video content may be identified based on machine learning. For example, a database may include information relating to prior user interactions of the video content with which the user interacted. The prior user interactions may include interactions of the present user and/or other users. The database may include information relating to other video content viewed and/or requested by the users after interacting with the video content as shown in FIG. 5 (or interacting with the video content in a similar manner). For example, the database may indicate that after one or more users interacted with the video content as shown in FIG. 5, these users (or a majority/plurality of these users) viewed video content relating to a particular vehicle. Identify component 104 may, based on spatial selections 500, identify as related video content those video content including/relating to the particular vehicle.

The database may include information relating to spatial selections of video content by one or more users associated with different video preferences. For example, the database may include information relating to spatial selections of the video content by users with video preference for surfing and users with video preference for hiking. Identify component 104 may compare the present user's spatial selections 500 of the video content with other users' spatial selections of the video content. Based on the comparison, identify component 104 may identify one or more users whose spatial selections mostly closely resembles spatial selection 500. For example, spatial selection 500 may more closely resemble spatial selections of the user(s) with video preference for hiking than spatial selections of the user(s) with video preference for surfing. Based on the resemblance, identify component 104 may identify as related video content those video content including/relating to hiking.

The database may include information relating to spatial selections of video content by one or more users associated with different user identifications. For example, the database may include information relating to spatial selections of the video content by users identified as men and users identified as women. Identify component 104 may compare the present user's spatial selections 500 of the video content with other users' spatial selections of the video content. Based on the comparison, identify component 104 may identify one or more users whose spatial selections mostly closely resembles spatial selection 500. For example, spatial selection 500 may more closely resemble spatial selections of the user(s) identified as women than spatial selections of the user(s) identified as men. Based on the resemblance, identify component 104 may identify as related video content those video content of interest to/viewed by women.

In some implementations, identifying related video content based on the spatial selections of the video content may include associating the user with one or more groups and identifying the related video content based on the group(s) with which the user is associated and/or other information. A group may refer to a collection of users who share one or more commonalities. One or more commonalities may be a temporary characteristic of the users or a permanent characteristic of the users. The users in a group may be characterized by one or more common characteristics. A common characteristic may refer to a feature and/or a quality shared by the users in a group. Common characteristics may include one or more of a common gender, a common age group, a common location, a common interest, and/or other common characteristics.

The user may be associated with one or more groups based on the spatial selections of the video content and/or other information. For example, the database may include information relating to spatial selections of video content by one or more users associated with different groups. For example, the database may include information relating to spatial selections of the video content by users associated with a music band A and users associated with a music band B. Identify component 104 may compare the present user's spatial selections 500 of the video content with other users' spatial selections of the video content. Based on the comparison, identify component 104 may identify one or more users whose spatial selections mostly closely resembles spatial selection 500. For example, spatial selection 500 may more closely resemble spatial selections of the user(s) associated with the music band A than spatial selections of the user(s) associated with the music band B. Based on the resemblance, identify component 104 may identify as related video content those video content including/relating to music band A. In some implementations, the related video content may be characterized as being of interest to one or more groups with which the user is associated. For example, the related video content may include video content characterized as being of interest to a group associated with music band A.

In some implementations, related video content may include particular view(s) within the related video content. For example, related video content may include visuals relating to the music band A, music band B, and/or other music bands. Different views of the related video content may exist. Different views of the related video content may include different orientations of fields of view within which the related video content may be viewed. The different orientations of the fields of view may be defined as a function of progress through the related video content. For example, one view of the related video content may include particular orientations of the fields of view that focus on music band A, and another view of the related video content may include particular orientations of the fields of view that focus on music band B. Based on spatial selection 500 indicating the user's interest in music band A, related video content may include a view of the related video content that focuses on music band A.

In some implementations, related video content may include one or more portions of the video content with which the user interacted. For example, receive component 102 may receive interaction information indicating how a user interacted with a first part of video content. Identify component 104 may, based on the user's spatial selections of the first part of the video content, identify related video content that includes a particular view of the second part of the video content. For example, the user's spatial selections of the first part of the video content may indicate the user's interest in music band A. The related video content may include a particular view of the second part of the video content that focuses on music band A. The related video content may include a view of the entire video content that focuses on music band A (allowing a user to view the video content from the start with a focus on music band A). The related video content may be characterized by one or more types of projections (e.g., stereographic projection, little planet projection, tunnel view projection, equirectangular projection, rectilinear projection, etc.).

In some implementations, associating the user with one or more groups may include determining one or more interests of the user corresponding to one or more of objects or events based on the spatial selections of the video content and/or other information. The spatial selections of the video content may include one or more of the viewing directions of the video content selected by the user that include one or more of the visual elements. For example, as shown in FIG. 6, visual content 300 may include visual element(s) corresponding to a music stage, visual element(s) corresponding to two trees, and/or other visual elements. Video content 300 may include visual element(s) corresponding to a music band (not shown in FIG. 6). The visual element(s) corresponding to the music band may appear within one or more portions of visual content 300 (e.g., performance area 600).

One or more interests of the user corresponding to particular objects/events may be determined based on one or more of the viewing directions of the video content selected by the user including the visual element(s) corresponding to the particular objects/events and/or other information. For example, an interest of the user corresponding to a music band/music band playing a song may be determined based on the viewing directions of the video content selected by the user including the visual element(s) corresponding to the music band/music band playing a song.

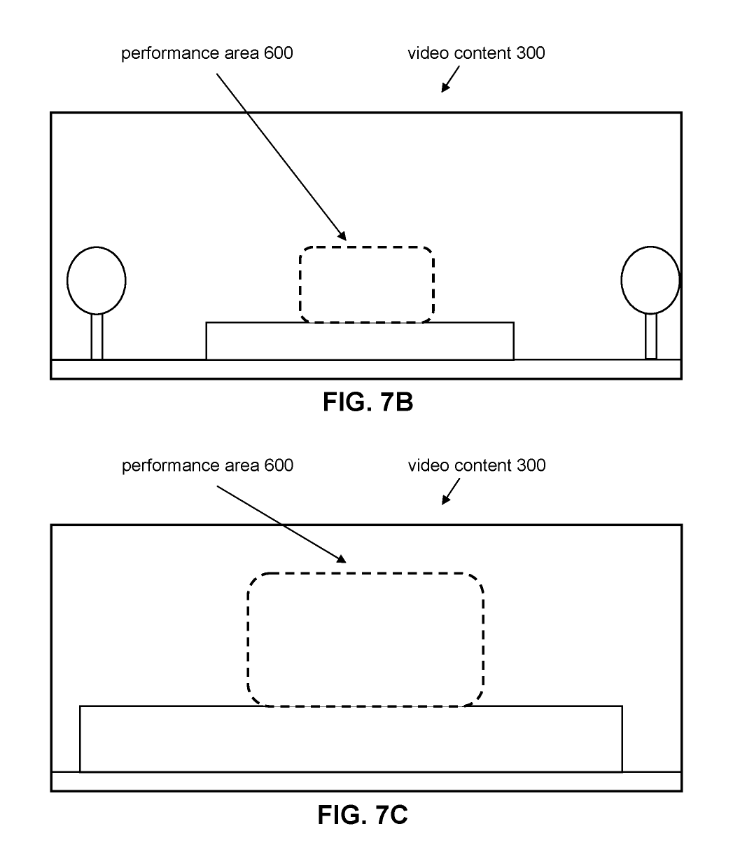

In some implementations, one or more interests of the user corresponding to particular objects/events may be determined further based on the spatial selections of the video content indicating the user changing the viewing directions of the video content to center on the corresponding visual element(s). For example, a user may change the viewing directions of video content 300 so that the view of video content 300 changes from those shown in FIG. 6 to those shown in FIG. 7A. As shown in FIG. 7A, performance area 600 may be centered within the view. Performance area 600 may include a music band/music band playing a song. An interest of the user corresponding to the music band/music band playing a song may be determined based on the centering of the view of video content 300 on the music band/music band playing a song.

In some implementations, one or more interests of the user corresponding to particular objects/events may be determined further based on the spatial selections of the video content indicating the user changing the viewing directions of the video content to follow the corresponding visual element(s). For example, a music band may be playing a song in the portion of video content 300 indicated as performance area 600. The music band may move across the stage so that the performance area 600 moves to the right, as shown in FIGS. 7A-7B. A user may change the viewing directions of video content 300 so that the view of the video content 300 changes to follow the music band/music band playing a song (e.g., following performance area 600 between FIGS. 7A-7B). An interest of the user corresponding to the music band/music band playing a song may be determined based on changes in the view of the video content 300 to follow the music band/music band playing a song.

In some implementations, one or more interests of the user corresponding to particular objects/events may be determined further based on the spatial selections of the video content indicating the user changing the viewing extents of the video content to zoom in on the corresponding visual elements. For example, a user may change the viewing directions of video content 300 so that the view of video content 300 changes from those shown in FIG. 7B to those shown in FIG. 7C. As shown in FIGS. 7B-7C, views of video content 300 may have been changed to zoom in on performance area 600. Performance area 600 may include a music band/music band playing a song. An interest of the user corresponding to the music band/music band playing a song may be determined based on the zooming of the view of video content 300 on the music band/music band playing a song.

In some implementations, one or more interests of the user corresponding to particular objects/events may be determined further based on the spatial selections of the video content indicating more than one change. For example, a user's interest corresponding to the music band/music band playing a song may be determined based on the user changing the view of the video content 300 to following the music band/music banding playing the song and zooming in on the music band/music band playing the song.

In some implementations, one or more interests of the user corresponding to particular objects/events may be determined further based on the spatial selections of the video content meeting or exceeding one or more thresholds and/or other information. For example, the spatial selections of the video content may need to center on the corresponding visual element(s) for a threshold duration. The spatial selections of the video content may need to center on the corresponding visual element(s) a threshold number of times. The spatial selections of the video content may need to follow the corresponding visual element(s) for a threshold duration. The spatial selections of the video content may need to zoom in on the corresponding visual element(s) for a threshold duration. The spatial selections of the video content may need to zoom in on the corresponding visual element(s) a threshold number of times. The spatial selections of the video content may need to zoom in on the corresponding visual element(s) at a threshold magnification.

In some implementations, associating the user with one or more groups may include associating the user with one or more interest groups based on one or more interests of the user and/or other information. For example, individual interest groups may be characterized by a common interest of the users associated with the individual interest groups. A common interest may refer to an interest commonly shared by the users in a group. For example, an interest of the user may correspond to a particular music band. The particular music band may be associated with a particular genre of music.

A first interest group may be characterized by a common interest of the users associated with the first interests group. The common interest may correspond to the particular music band. A second interest group may be characterized by a different common of the users associated with the second interest group. The different common interest may correspond to the particular genre of music. The interest corresponding to the particular music band may be a subset of the interest corresponding to the particular genre of music.

The user may be associated with a first interest group based on the interest of the user including the common interest corresponding to the particular music band and/or other information. The user may be associated with the second interest group based on the interest of the user corresponding to the particular interest group being a subset of the interest correspond to the particular genre of music.

The related video content may be identified further based on the interest group with which the user is associated and/or other information. Related video content may be characterized as being of interest to one or more interest groups with which the user is associated. The related video content may include one or more video content based on the user being associated with a particular interest group and/or other information. The related video content may include one or more video content that include visual element(s) corresponding to the common interest(s) and/or other visual elements. For example, related video content may include video relating to the particular music band and/or particular genre of music based on the user being associated with the particular interest group corresponding to the particular music band and/or the particular genre of music.

Offer component 106 may be configured to offer the related video content to the user. Offering the related video content user may include providing one or more links to the related video content, transmitting the related video content to the user, and/or other offerings of the related video content to the user. For example, offer component 106 may provide a list of related video content (e.g., a recommended view list, etc.), which may allow a user to selected and/or view the related video content. Offer component 106 may transmit the related video content to the user. In some implementations, offer component 106 may switch from providing a recommended view list to directly transmitting the related video content. For example, identify component 104 may identify only one related video content. Instead of providing a recommended view list listing a single video content, offer component 106 may transmit the video content to the user. Other types of offering of the related video content are contemplated.

In some implementations, the related video content may be offered to the user based on one or more rankings of the related video content and/or other information. For example, offer component 106 may store and/or access information in a database relating to prior views of the related video content by the user and/or other users. Related video content may be ranked by the user and/or other users. Related video content that is more often viewed in full by the user and/or other users may be ranked higher than related video content that is more often viewed only in parts. Related video content that is more often selected by the user and/or other users may be ranked higher than related video content that is selected less often. Ranking may be determined based on user preference. For example, a user may prefer video content of certain duration(s) and/or longer/shorter duration(s).

While the present disclosure may be directed to video content, one or more other implementations of the system may be configured for other types media content. Other types of media content may include one or more of audio content (e.g., music, podcasts, audio books, and/or other audio content), multimedia presentations, photos, slideshows, and/or other media content.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although processor 11 and electronic storage 12 are shown to be connected to an interface 13 in FIG. 1, any communication medium may be used to facilitate interaction between any components of system 10. One or more components of system 10 may communicate with each other through hard-wired communication, wireless communication, or both. For example, one or more components of system 10 may communicate with each other through a network. For example, processor 11 may wirelessly communicate with electronic storage 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although processor 11 is shown in FIG. 1 as a single entity, this is for illustrative purposes only. In some implementations, processor 11 may comprise a plurality of processing units. These processing units may be physically located within the same device, or processor 11 may represent processing functionality of a plurality of devices operating in coordination. Processor 11 may be configured to execute one or more components by software; hardware; firmware; some combination of software, hardware, and/or firmware; and/or other mechanisms for configuring processing capabilities on processor 11.

It should be appreciated that although computer components 102, 104, and/or 106 are illustrated in FIG. 1 as being co-located within a single processing unit, in implementations in which processor 11 comprises multiple processing units, one or more of computer program components 102, 104, and/or 106 may be located remotely from the other computer program components.

The description of the functionality provided by the different computer program components described herein is for illustrative purposes, and is not intended to be limiting, as any of computer program components may provide more or less functionality than is described. For example, one or more of computer program components 102, 104, and/or 106 may be eliminated, and some or all of its functionality may be provided by other computer program components. As another example, processor 11 may be configured to execute one or more additional computer program components that may perform some or all of the functionality attributed to one or more of computer program components 102, 104, and/or 106 described herein.

The electronic storage media of electronic storage 12 may be provided integrally (i.e., substantially non-removable) with one or more components of system 10 and/or removable storage that is connectable to one or more components of system 10 via, for example, a port (e.g., a USB port, a Firewire port, etc.) or a drive (e.g., a disk drive, etc.). Electronic storage 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 12 may be a separate component within system 10, or electronic storage 12 may be provided integrally with one or more other components of system 10 (e.g., processor 11). Although electronic storage 12 is shown in FIG. 1 as a single entity, this is for illustrative purposes only. In some implementations, electronic storage 12 may comprise a plurality of storage units. These storage units may be physically located within the same device, or electronic storage 12 may represent storage functionality of a plurality of devices operating in coordination.

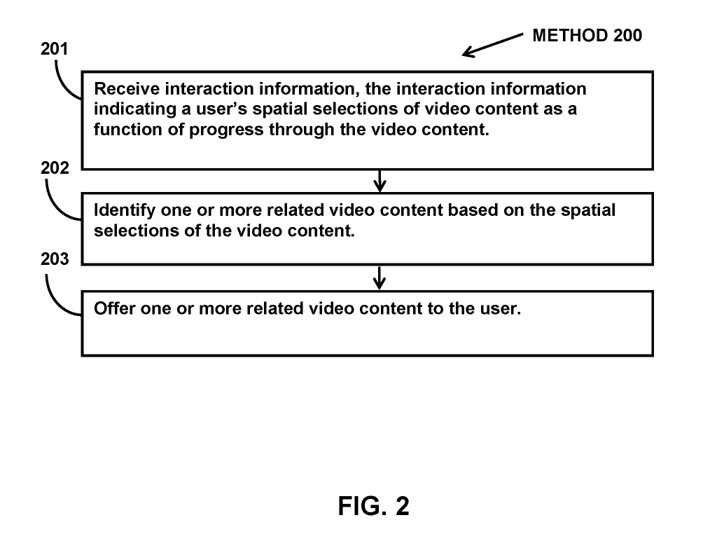

FIG. 2 illustrates method 200 for offering different video content to different groups of users. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage mediums. The one or more processing devices may include one or more devices configured through hardware, firmware, and/or software to be specifically designed for execution of one or more of the operations of method 200.

Referring to FIG. 2 and method 200, at operation 201, interaction information may be received. Interaction information may indicate a user's spatial selections of video content as a function of progress through the video content. The spatial selections of the video content may include viewing directions of the video content selected by the users as the function of progress through the video content. In some implementations, operation 201 may be performed by a processor component the same as or similar to receive component 102 (shown in FIG. 1 and described herein).

At operation 202, one or more related video content may be identified. Related video content may be identified based the spatial selections of the video content. In some implementations, operation 202 may be performed by a processor component the same as or similar to identify component 104 (shown in FIG. 1 and described herein).

At operation 203, one or more related video content may be offered to the user. In some implementations, operation 203 may be performed by a processor component the same as or similar to offer component 106 (shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementations.

1. A system for offering different video content to different groups of users, the system comprising:
one or more physical processors configured by machine-readable instructions to:
receive interaction information indicating a user's spatial selections of first spherical video content as a function of progress through the first spherical video content, the spatial selections of the first spherical video content including viewing directions of the first spherical video content selected by the user as the function of progress through the first spherical video content, the viewing directions of the first spherical video content corresponding to orientations of fields of view of the first spherical video content within which the user interacted with the first spherical video content, wherein the viewing directions of the first spherical video content are characterized by a yaw parameter and a pitch parameter, the yaw parameter defining an amount of yaw rotation for the first spherical video content and the pitch parameter defining an amount of pitch rotation for the first spherical video content;
identify related video content based on the spatial selections of the first spherical video content; and
offer the related video content to the user.

2. The system of claim 1, wherein identifying the related video content based on the spatial selections of the first spherical video content includes:
associating the user with a group based on the spatial selections of the first spherical video content; and
identifying the related video content based on the group with which the user is associated.

3. The system of claim 2, wherein the related video content is characterized as being of interest to the group with which the user is associated.

4. The system of claim 2, wherein:
the first spherical video content includes one or more visual elements, the one or more visual elements corresponding to one or more objects or events captured within the first spherical video content, the one or more visual elements including a first visual element corresponding to a first object or a first event, and
associating the user with the group includes determining an interest of the user corresponding to one or more of the objects or the events based on the spatial selections of the first spherical video content, the spatial selections of the first spherical video content including one or more of the viewing directions of the first spherical video content selected by the user that include the one or more of the visual elements, wherein a first interest of the user corresponding to the first object or the first event is determined based on the one or more of the viewing directions of the first spherical video content selected by the user including the first visual element.

5. The system of claim 4, wherein the first interest of the user corresponding to the first object or the first event is determined further based on the spatial selections of the first spherical video content indicating the user changing the viewing directions of the first spherical video content to center on the first visual element.

6. The system of claim 4, wherein the first interest of the user corresponding to the first object or the first event is determined further based on the spatial selections of the first spherical video content indicating the user changing the viewing directions of the first spherical video content to follow the first visual element.

7. The system of claim 4, wherein:
the spatial selections of the first spherical video content include viewing extents of the first spherical video content selected by the user as the function of progress through the first spherical video content; and
the first interest of the user corresponding to the first object or the first event is determined further based on the spatial selections of the first spherical video content indicating the user changing the viewing extents of the first spherical video content to zoom in on the first visual element.

8. The system of claim 4, wherein the first interest of the user corresponding to the first object or the first event is determined further based on the spatial selections of the first spherical video content meeting or exceeding a threshold.

9. The system of claim 4, wherein:
associating the user with the group includes associating the user with an interest group based on the interest of the user, individual interest groups characterized by a common interest of the users associated with the individual interest groups, wherein the user is associated with a first interest group based on the first interest of the user including a first common interest, the first interest group characterized by the first common interest of the users associated with the first interest group; and
the related video content is identified further based on the interest group with which the user is associated, the related video content including second video content based on the user being associated with the first interest group, the second video content including a second visual element corresponding to the first common interest.

10. A method for offering different video content to different groups of users, the method comprising:
receiving interaction information indicating a user's spatial selections of first spherical video content as a function of progress through the first spherical video content, the spatial selections of the first spherical video content including viewing directions of the first spherical video content selected by the user as the function of progress through the first spherical video content, the viewing directions of the first spherical video content corresponding to orientations of fields of view of the first spherical video content within which the user interacted with the first spherical video content, wherein the viewing directions of the first spherical video content are characterized by a yaw parameter and a pitch parameter, the yaw parameter defining an amount of yaw rotation for the first spherical video content and the pitch parameter defining an amount of pitch rotation for the first spherical video content;
identifying related video content based on the spatial selections of the first spherical video content; and
offering the related video content to the user.

11. The method of claim 10, wherein identifying the related video content based on the spatial selections of the first spherical video content includes:
associating the user with a group based on the spatial selections of the first spherical video content; and
identifying the related video content based on the group with which the user is associated.

12. The method of claim 11, wherein the related video content is characterized as being of interest to the group with which the user is associated.

13. The method of claim 11, wherein:
the first spherical video content includes one or more visual elements, the one or more visual elements corresponding to one or more objects or events captured within the first spherical video content, the one or more visual elements including a first visual element corresponding to a first object or a first event, and
associating the user with the group includes determining an interest of the user corresponding to one or more of the objects or the events based on the spatial selections of the first spherical video content, the spatial selections of the first spherical video content including one or more of the viewing directions of the first spherical video content selected by the user that include the one or more of the visual elements, wherein a first interest of the user corresponding to the first object or the first event is determined based on the one or more of the viewing directions of the first spherical video content selected by the user including the first visual element.

14. The method of claim 13, wherein the first interest of the user corresponding to the first object or the first event is determined further based on the spatial selections of the first spherical video content indicating the user changing the viewing directions of the first spherical video content to center on the first visual element.

15. The method of claim 13, wherein the first interest of the user corresponding to the first object or the first event is determined further based on the spatial selections of the first spherical video content indicating the user changing the viewing directions of the first spherical video content to follow the first visual element.

16. The method of claim 13, wherein:
the spatial selections of the first spherical video content include viewing extents of the first spherical video content selected by the user as the function of progress through the first spherical video content; and
the first interest of the user corresponding to the first object or the first event is determined further based on the spatial selections of the first spherical video content indicating the user changing the viewing extents of the first spherical video content to zoom in on the first visual element.

17. The method of claim 13, wherein the first interest of the user corresponding to the first object or the first event is determined further based on the spatial selections of the first spherical video content meeting or exceeding a threshold.

18. The method of claim 13, wherein:
associating the user with the group includes associating the user with an interest group based on the interest of the user, individual interest groups characterized by a common interest of the users associated with the individual interest groups, wherein the user is associated with a first interest group based on the first interest of the user including a first common interest, the first interest group characterized by the first common interest of the users associated with the first interest group; and
the related video content is identified further based on the interest group with which the user is associated, the related video content including second video content based on the user being associated with the first interest group, the second video content including a second visual element corresponding to the first common interest.

19. (canceled)

20. (canceled)

21. The system of claim 1, wherein the viewing directions of the first spherical video content are further characterized by a roll parameter, the roll parameter defining an amount of roll rotation for the first spherical video content.

22. The system of claim 1, wherein identification of the related video content is performed based on comparison of the user's spatial selections of first spherical video content with other users' spatial selections of first spherical video content, and the related video content is associated with one or more of the other users with spatial selections of the first spherical video content similar to the user's spatial selections of first spherical video content.
